(19) United States
(12) Patent Application Publication
(10) Pub. No.: US 2002/0078352 A1
(43) Pub. Date: Jun. 20, 2002

(54) Secure communication by modification of security codes

(75) Inventors: Alastair John Angwin, Eastleigh (GB); Stefan Georg Hild, Somers, NY (US); Sandeep Singhal, Englewood Cliffs, NJ (US)

Correspondence Address: IBM CORPORATION, 3039 CORNWALLIS RD., DEPT. T81 / B503, PO BOX 12195, REASEARCH TRIANGLE PARK, NC, 27709, US

(73) Assignee: International Business Machines Corporation, Armonk, NY (US)

(21) Appl. No.: 09/737,627

(22) Filed: Dec. 15, 2000

(51) Int. Cl. H04L 9/00

(52) U.S. Cl. 713/169

(57) ABSTRACT

A method, system and computer program for secure electronic communication by modifying a security code for use in a plurality of separate electronic communications between a first party and a second party involves the initial secure exchange of a seed value. Additionally, a relatively simple advance function and a one-way hash function are exchanged. When a new communication, for example following a disconnection, is required, both parties apply the advance function to the seed value and then hash the result to each create a new security code. If the tokens at the two parties are the same, the communication is allowed to proceed. The invention is applicable to both client and server in a client/server system, where the client may be a cellular phone or a personal digital assistant.

### FIELD OF THE INVENTION

The invention relates generally to secure communication by exchange of modified security codes and, in particular, to the establishing of secure reconnection between communicating nodes in a network.

### BACKGROUND OF THE INVENTION

In order to exchange data securely between two nodes of a network over a communications link, it is normal practice for the nodes to establish each other's identity prior to transmission of any secure data. There are numerous methods available for accomplishing this mutual authentication based, for example, on private keys and/or publicly known keys in combination with public key infrastructure. The protocol for establishing authenticity may require lengthy and therefore expensive exchanges and associated computation at both nodes (refer, for example, to the article “New Directions in Cryptography”, W. Diffie and M. E. Hellman, IEEE Transactions on Information Theory, Vol.IT-22, No.6, June 1977, pp 74-84.)

If the link between nodes is lost, either by physical disconnection or disconnection by termination of a communications session, then one possibility for re-establishing communication would be to repeat the initial authentication process. However, if the likelihood of repeated disconnection is high, as in fragile wireless communication systems such as are used to connect mobile phones or personal digital assistants (PDAs) to a data server, then full reauthentication is not an economic option. Yet simple reconnection by, for example, exchange of an unvarying key or password is too insecure as the password may be intercepted and reused by unauthorised parties.

Analogous problems have arisen in other applications in the past. For example, in U.S. Pat. No. 5,146,498 “Remote key manipulation for over-the-air rekeying”, mobile radio equipment designed for secure encrypted voice communication stores a key used in decrypting and encrypting voice or data messages. If the key becomes compromised and it is desired to change it, a central controller transmits openly a key change operation code. This code identifies to the radio one of a number of stored logical or algebraic operations to be performed on the original key to transform it into a new key which the controller will subsequently use for encryption of signals. This is not the result of a disconnection as such but rather the result of a deliberate decision to change the stored key.

In U.S. Pat. No. 5,191,610 “Remote operating system having secure communication of encoded messages and automatic resynchronization”, there is discussed a prior system in which a transmitter and a receiver both share a common “seed” value. On each activation of the transmitter, identical pseudo random number generators in both transmitter and receiver generate a new number, initially from the seed value, which is used as a key. If both transmitter and receiver have identical keys, then a command, for example, to open a garage door, is executed at the receiver. Both versions of the key should change identically on each transmission. The patent goes on to propose the use of a counter to assist resynchronization of the keys if transmitter and receiver get out of step due to a failure in transmission or reception.

A more sophisticated scheme, known in the field of wireless communication for data processing, is known as “chained hashing”. Hashing is a well known technique for transforming an input string of data of arbitrary length into a fixed length output which is unrecognisable as being derived from the input. A so called one way hash function is particularly useful in the cryptographic field because it is impossible or extremely difficult to derive the original input from the hash value.

In chained hashing, a hash function h(x) is repeatedly applied to a seed value sᵢ to produce a long sequence of hash values:s₁=h(s₀), s₂=h(s₁), s₃=h(S₂), . . . , at both nodes. The new hash values may be compared after each loss of communication and, if they are the same, communication may be safely resumed. In practice, an extra level of security is added by using the hash values in reverse order: . . . s₅, s₄, . . . s₁, or by one partner selecting a particular number hash value, s₄ say, to be provided for comparison by the other partner.

A disadvantage of the chained hashing technique is that either the sequence of hash values has to be precomputed and stored by both partners or it has to be computed afresh each time there is a disconnection. If reverse order is used, then the number of permissible reconnections is finite.

### SUMMARY OF THE INVENTION

There is therefore a need for a simpler but reasonably secure method of controlling separate electronic communications by repeated modification of security codes to allow, for example, reauthentication of communicating nodes following disconnection.

Accordingly, in an electronic communications system for providing communication between at least a first party and a second party and having means for connecting said first and second parties for electronic communication and means for controlling secure communication between said first and second parties by the exchange of security codes between said parties, the invention provides a method of controlling a plurality of separate electronic communications between said first and second parties, said method comprising the steps of: (a) initially securely exchanging a seed value between said first and second parties; (b) exchanging a mathematical advance function between said parties; and (c) exchanging a one-way hash function between said parties; said method further comprising, prior to each separate communication, the steps of: (d) applying said advance function to the seed value to create a new seed value at each of said parties; (e) applying said hash function to said new seed value to create a said security code at each of said parties; (f) communicating said security code generated at said first party to said second party; (g) comparing said communicated security code with said security code generated at said second party; and (h) if said security codes are the same at both parties, permitting the respective communication to take place between said first and second parties.

In alternative aspects the invention also provides an electronic communications system having means for carrying out the inventive method and a computer program which, when executed, carries out the method steps.

Also the invention provides a client computer which calculates a new security code from a see value, advance function and hash function supplied to it by a server computer and returns the new security code to the server for comparison with a server calculated version.

Finally, the invention provides a server computer with means for comparing such a client calculated security code with a server calculated security code and permitting secure communication if the two codes are the same.

Thus, by combining a relatively simple advance function with the security of the hash function, a rapid method of changing a secure key without being able to predict it is provided, which does not require large storage or repeated computations for each of a number of separate communications. In a cellular phone environment, connection time charges will consequently be reduced. Nor is there any limit on the number of times a new secure key may be produced.

The invention is applicable where the two parties are any two nodes in a network. Such nodes could be peer nodes but, in the context of the Internet, are more likely to be a client running browser software and a server.

Where the separate communications each follow a disconnection of said first and second parties, the steps (a) to (c) of the method of the invention precede such disconnection and the method includes the further step of physically re-establishing the connection between the parties prior to the steps (d) to (g).

The reference to a disconnection is intended to cover both failure of the physical communications layer, such as a telephone line failure or radio wave interference, and also a suspension of a communications session under a communications protocol. Although the intended application of the invention is to disconnection of nodes in a communications network, it could also be employed more generally in exchange of security codes prior to transmission, irrespective of whether a disconnection had occurred or not.

Preferably, the advance function is non-recursive and may be a simple arithmetic function, such as an incrementing function or multiplication.

If desired, the advance and hash functions can also be exchanged securely.

For added security, the process may be repeated to achieve mutual authentication, i.e. the second node may repeat the process before communication is permitted, so that the new seed value is advanced to provide a further new seed value, which is hashed to generate a further token at each node. The further tokens may then be additionally compared to doubly ensure secure communication should be permitted to resume.

### BRIEF DESCRIPTION OF THE DRAWINGS

The invention will now be described, by way of example only, with reference to a preferred embodiment thereof, as illustrated in the accompanying drawings, in which

FIG. 1 illustrates a known wireless network in which wireless devices are in communication with a server over the Internet;

FIG. 2 is a flow diagram of a client/server authentication process including the initial steps of a method according to the present invention; and

FIG. 3 is a flow diagram of the remaining steps of a security code modification method according to the invention for re-establishing secure communication between parties in the network of FIG. 1.

### DETAILED DESCRIPTION OF A PREFERRED EMBODIMENT OF THE INVENTION

Communication over the Internet for the transfer of information, including the making of on-line purchases, involves a client device, running an application known as a browser, communicating with a remote server which provides the required information or executes the purchase transaction. Whereas much Internet traffic is still generated by desktop or laptop computers, connected by modem and carried over the conventional telecommunications network, there is increasing interest in the use of mobile phones or personal digital assistants (PDAs), also known as palm top devices, for Internet communications.

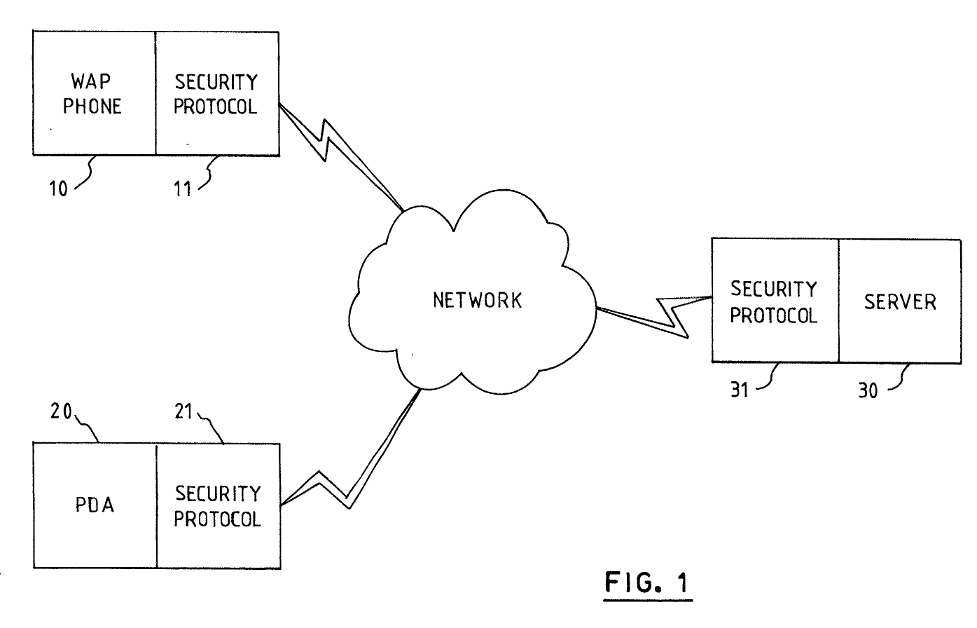

Mobile phones and some PDAs use wireless telecommunication over a cellular network, as illustrated in FIG. 1. Sometimes, special communications protocols, for example, WAP (Wireless Application Protocol), are used to facilitate the use of this type of device with the Internet. In FIG. 1, a mobile WAP phone 10 and a palm top PDA 20 are clients connected wirelessly to a data server 30, via the Internet. When one of the clients wishes to communicate with the server, a communications session must be established over the physical link. In a secure environment, an authentication protocol must be followed in which the two parties engage in a lengthy and expensive exchange of information to establish each other's identity. As already indicated, there are numerous known methods for accomplishing this mutual authentication, which are either based on securely exchanged private keys or on non-communicated private key and exchanged public key information in combination with public key infrastructures. Accordingly, each of the devices in FIG. 1 is provided with its own security protocol software 11, 21 and 31, respectively, to control secure communication between the client devices, 10 and 20, and the server 30.

However, connection of pervasive devices such as a WAP enabled phone 10 or a PDA 20 to a data server 30 via a fragile wireless link can result in frequent session disconnections, either due to network failures or intentionally to save connection costs (to a lesser extent this also occurs on wired networks and within the Internet). This obliges the user to have to make frequent attempts to resume a previously established session. In a secure data environment, this also involves the renegotiation of security parameters or the reauthentication of the communicating partners. To completely repeat the full authentication procedure is expensive and although chained hashing, as described above, is less expensive, it still needs significant computation or storage resources and only allows a limited number of reconnections.

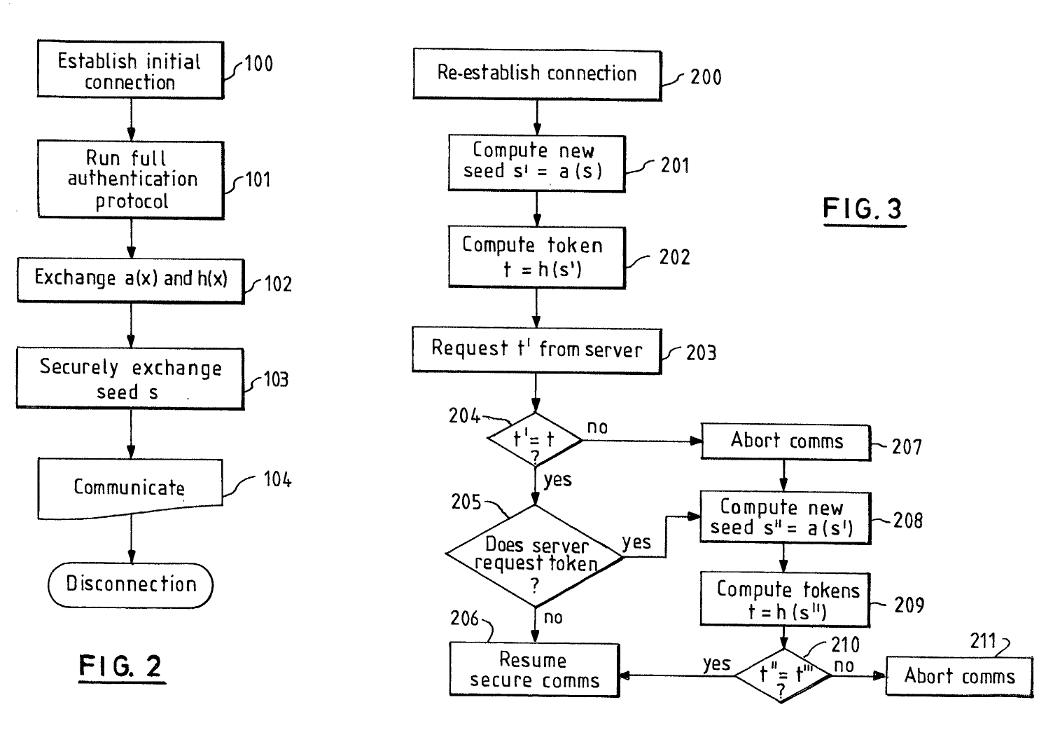

An alternative mechanism to prove client identity in order to resume a session is described with reference to FIGS. 2 and 3. It requires minimal state and the number of resumptions is unlimited.

The invention requires that the client and server agree on:

a seed value (s)

an advance function a(x), for example a(x)=x+1,

a one-way hash function h(x)

This can be achieved during the initial client/server authentication, as illustrated in FIG. 2, in which a communications session between client and server is established in step 100. This involves making the physical connection and thereafter following a communications protocol to allow open exchange of data over the physical link. As there is a requirement to exchange secure data, the initial communication is the running of an authentication protocol, in step 101, to identify the participants to each other and to exchange such keys as are necessary to allow encryption and decryption functions by both parties. Although not necessary to an understanding of the invention, a suitable example of an existing authentication scheme is described in the above referenced article by Diffie and Hellman. Other examples are RSA Laboratories' “Public Key Cryptography Standards” (PKCS) available from the web site www.rsasecurity.com/rsalabs/pkcs.

Once a secure connection has been established, the advance function a(x) and the hash function h(x) are also exchanged in step 102. In fact, these two functions do not need to be kept secure and may be exchanged as plain text. However, they may be kept secure for additional security, if desired.

The seed value ‘s’, which is security sensitive, is next exchanged securely in step 103. There is no need for the seed value to be a large number, as long as it cannot be guessed. The security requirement during the set-up phase is therefore minimal. It should be noted that both client and server are required to retain ‘s’, a(x), and h(x) in their working memory. Communication between the two parties then proceeds normally in step 104.

If connection between the client and server is then lost, this stored information is sufficient to enable reestablishment of the secure exchange, as described in connection with FIG. 3. To resume a disconnected session, in step 200, the client reconnects to the server and identifies the session which it wishes to resume. In addition, the client performs the following operations:

In step 201, the seed s is advanced: s′=a(s) and s′ is now stored in place of s.

By way of a simple example, if the seed value is 12345 and the advance function is a(x)=x+1, then the new seed value is 12346. Any non recursive and therefore relatively simple advance function may be used in practice to keep down computational overheads. The significant point is that the advance function should be quick to compute.

In step 202, the new seed is hashed, generating a token t:t=h(s′).

The token is effectively a new security code.

Again, in a simple example if the hash function is h(x)=x mod 3, the result from 12346 is “1”. It will be realised that in practice a more computationally complex hash function would need to be used. As stated above, the function must be one way. An example of a practical hash function is one defined by R. Rivest “The MD5 Message Digest Algorithm”, April 1992, now available as RFC 1321 on the web site of the Internet Engineering Task Force at www.ietf.org under the section headed “RFC” (Request for Comments).

The client next transmits the generated token t to the server. As t is a one-time token (due to the advance function), it can be transmitted in plain text. In step 203, the server executes the same computation to generate the server-side token t′. If, in step 204, t′=t, the client is the same client that executed the previous authentication and is permitted to resume the session at step 206. If the tokens are not equal, the reauthentication fails and the attempt to re-establish communication is aborted in step 207.

The new method thus shortcuts the problem of re-establishing mutual authenticity. The idea is that, once the identification has once been mutually established using one of the known mechanisms, an additional secret seed value, together with advance and hash functions, are exchanged which allows the two parties to re-establish their identification later on more quickly and without the large overhead in communications and computations that the original authentication step required. There is no limit to the number of times mutual re-authentication may take place as the series of tokens may continue indefinitely, in cascade, yet with each new token being a completely unique security code.

For additional security, the method may be repeated with the roles reversed, i.e. the requesting party must now compute the next token t″ (using the same advance function as before) and transmit that token to the other party, thus proving its identity. Thus, in step 205, the server indicates whether or not it wants to request a token from the client. If it does, then a further new seed value s″ is computed by both parties in step 208 by applying the advance function to the stored new seed value s′. The further seed value s″ is hashed in step 209 to compute further tokens t″ and t″′ on the server and client sides respectively. These tokens are compared in step 210 and, if equal, the secure connection is re-established in step 206. If they are not equal, the authentication and, consequently, the communication is aborted in step 211.

1. In an electronic communications system for providing communication between at least a first party and a second party and having means for connecting said first and second parties for electronic communication, and means for controlling secure communication between said first and second parties by the exchange of security codes between said parties,
a method of controlling a plurality of separate electronic communications between said first and second parties, said method comprising the steps of
(a) initially securely exchanging a seed value between said first and second parties;
(b) exchanging a mathematical advance function between said parties; and
(c) exchanging a one-way hash function between said parties;
said method further comprising, prior to each separate communication, the steps of:
(d) applying said advance function to the seed value to create a new seed value at each of said parties;
(e) applying said hash function to said new seed value to create a said security code at each of said parties;
(f) communicating said security code generated at said first party to said second party;
(g) comparing said communicated security code with said security code generated at said second party; and
(h) if said security codes are the same at both parties, permitting the respective communication to take place between said first and second parties.

2. A method as claimed in claim 1 wherein said separate communications each follow a disconnection of said first and second parties, said steps (a) to (c) preceding such disconnection, said method including the further step of physically re-establishing said connection between said parties prior to said steps (d) to (g).

3. A method as claimed in claim 1 wherein said advance function is non-recursive.

4. A method as claimed in claim 3 wherein said advance function is an arithmetic function.

5. A method as claimed in claim 1 wherein said advance function and said hash function are also exchanged securely.

6. A method as claimed in claim 1 in which, if said security code is the same, after said comparing step (g), comprises the further steps, prior to permitting resumption of communication between said first and second parties, of:
applying the advance function to said new seed value at each of said parties to create a further new seed value;
applying the hash function to said further new seed value to create a further security code at each of said parties;
communicating said further security code generated at said second party to said first party;
comparing said further security codes received at said first party with the further security code generated at said first party; and
if said further security code is also the same at both nodes, permitting said communication between said first and second parties to take place.

7. A secure electronic communications system comprising means for connecting at least a first party and a second party for electronic communication; and
means for controlling a plurality of separate electronic communications between said first and second parties by the exchange of security codes between said parties;
wherein said means for controlling includes:
means for initially securely exchanging a seed value between said first and second parties;
means for exchanging a mathematical advance function between said parties; and
means for exchanging a one-way hash function between said parties;
means for applying said advance function to said seed value to create a new seed value at each of said parties prior to each separate communication;
means for applying said hash function to said new seed value to create a said security code at each of said parties;
means for communicating said security code generated at said first party to said second party;
means for comparing said communicated security code with said security code generated at said second party; and
means responsive to said security codes being the same at both parties to permit the respective communication to take place between said first and second parties.

8. A system as claimed in claim 7 wherein said separate communications each follow a disconnection of said first and second parties, said system including means for physically re-establishing said connection between said parties.

9. A system as claimed in claim 7 wherein said advance function is non-recursive.

10. A system as claimed in claim 9 wherein said advance function is an arithmetic function.

11. A system as claimed in claim 7 including said means for exchanging said advance function and said hash function securely.

12. A computer program, recorded on a medium, for use in an electronic communications system for providing communication between at least a first party and a second party, said system having means for connecting said first and second parties for electronic communication and means for controlling secure communication between said first and second parties by the exchange of security codes between said parties, said computer program comprising instructions which, when executed on a computer, carry out a method of controlling a plurality of separate electronic communications between said first and second parties, comprising the steps of
(a) initially securely exchanging a seed value between said first and second parties;
(b) exchanging a mathematical advance function between said parties; and
(c) exchanging a one-way hash function between said parties;
said method further comprising, prior to each separate communication, the steps of:
(d) applying said advance function to the seed value to create a new seed value at each of said parties;
(e) applying said hash function to said new seed value to create a said security code at each of said parties;
(f) communicating said security code generated at said first party to said second party;
(g) comparing said communicated security code with said security code generated at said second party; and
(h) if said security codes are the same at both parties, permitting the respective communication to take place between said first and second parties.

13. A computer program as claimed in claim 12 wherein said separate communications each follow a disconnection of said first and second parties, said method steps (a) to (c) preceding such disconnection, said method including the further step of physically re-establishing said connection between said parties prior to said steps (d) to (g).

14. A computer program as claimed in claim 12 wherein said advance function is non-recursive.

15. A computer program as claimed in claim 14 wherein said advance function is an arithmetic function.

16. A computer program as claimed in claim 12 wherein said advance function and said hash function are also exchanged securely.

17. A computer program as claimed in claim 12 in which, if said security code is the same, after said comparing step (g), carries out the further method steps, prior to permitting resumption of communication between said first and second parties, of:
applying the advance function to said new seed value at each of said parties to create a further new seed value;
applying the hash function to said further new seed value to create a further security code at each of said parties;
communicating said further security code generated at said second party to said first party;
comparing said further security codes received at said first party with the further security code generated at said first party; and
if said further security codes are also the same at both parties, permitting said communication between said first and second parties to take place.

18. A client computer connectable for secure communication with a server computer, said client computer comprising:
means for receiving from said server computer a seed value, a mathematical advance function and a one-way has function;
means for applying said advance function to said seed value to create a new seed value;
means for applying said hash function to said new seed value to create a security code;
and means for communicating said security code to said server computer;
whereby said server computer permits secure communication with said client computer if a security code correspondingly calculated by said server is identical to said security code communicated by said client computer.

19. A client computer as claimed in claim 18 wherein said advance function is non-recursive.

20. A client computer as claimed in claim 19 wherein said advance function is an arithmetic function.

21. A client computer as claimed in claim 18 which is a cellular telephone.

22. A client computer as claimed in claim 21 which is WAP enabled.

23. A client computer as claimed in claim 18 which is a personal digital assistant.

24. A server computer connectable for secure communication with one or more client computers, said server computer comprising means for providing to said client computer a seed value, a mathematical advance function and a one-way hash function;
means for applying said advance function to said seed value to create a new seed value;
means for applying said hash function to said new seed value to create a security code;
means for receiving a correspondingly calculated security code from said client computer;
means for comparing said security codes; and
means responsive to said security codes being the same to enable secure communication to take place with said client computer.

25. A server computer as claimed in claim 24 wherein said advance function is non-recursive.

26. A server computer as claimed in claim 25 wherein said advance function is an arithmetic function.
